(19) United States
(12) Patent Application Publication
(10) Pub. No.: US 2003/0035959 A1
(43) Pub. Date: Feb. 20, 2003

(54) Surface coating film and process for forming the same

(76) Inventors: Hitotoshi Murase, Kariya-shi (JP); Toshihisa Shimo, Kariya-shi (JP)

Correspondence Address: MORGAN & FINNEGAN, L.L.P., 345 Park Avenue, New York, NY, 10154, US

(21) Appl. No.: 10/178,632

(22) Filed: Jun. 24, 2002

(30) Foreign Application Priority Data
Jun. 25, 2001 (JP) 2001-191578 (PAT.

(51) Int. Cl. B32B 27/36

(52) U.S. Cl. 428/412

(57) ABSTRACT

A surface coating film coated on a substrate includes at least one member being selected from the group consisting of silicon dioxide and silicon dioxide derivatives, and an additive including polyvinyl pyrrolidone (PVP) being dispersed or solved therein. A forming process therefor includes the steps of applying a coating solution on a surface of a substrate, the coating solution including at least one silicon containing compound, being selected from the group consisting of alkoxy silane, siloxane and organosiloxane, and an additive including PVP, and heating the substrate. Since PVP is dispersed or solved in the surface coating film, it is possible to improve the wear resistance and superficial hardness. Moreover, since the surface coating film is enhanced in terms of the toughness, no crack occurs even when it is formed by polymerization reactions.

### BACKGROUND OF THE INVENTION

1. Field of the Invention

The present invention relates to a surface coating film and a process for forming the same.

2. Description of the Related Art

For automotive windows, and the like, inorganic glass products have been used in general. Recently, however, instead of inorganic glass products, it has been proposed to use transparent resinous products which are lightweight and good in terms of the processability. Moreover, regarding machine elements, such as gears, etc., as well, it has been proposed to use resinous products, which are good in terms of the moldability, instead of metallic products.

However, resinous products are not sufficiently superior to inorganic glass products and metallic products in terms of the wear resistance, and are accordingly applied to limited fields. Hence, it has been investigated to improve the wear resistance, and so on, by forming a film, which exhibits a wear resistance, on a surface of resinous products. Moreover, with regard to monitor devices of mobile information appliances, and the like, resinous products, which exhibit a high shock resistance, have been used widely. For monitor devices of mobile information appliances, etc., touch panels have been used in many cases, and are required to exhibit a high superficial wear resistance, and so on.

For example, the following technique has been proposed as a way to improve the wear resistance and superficial hardness of resinous products. A surface coating film, in which a silicon dioxide derivative being derived from alkoxy silane, and the like, is a major component, is formed on a surface of resinous products.

The surface coating film is generally poor in terms of the adherence with respect to resinous products. In order to improve the poor adherence, a prior art has been known in which a primer layer is formed between the surface coating film and resinous products. Alternatively, there has been such a surface coating film, which contains polyethylene glycol, that is disclosed in Japanese Unexamined Patent Publication (KOKAI) No. 2001-79,980.

However, there arise cases where even the surface coating films known as prior art cannot sufficiently satisfy the wear resistance. Accordingly, it has been required to further improve the wear resistance. Moreover, in prior art, when a surface coating film is formed on a surface of resinous products by the polymerization of alkoxy silane as described above, the resulting surface coating film is cracked by the polymerization shrinkage accompanied by the reaction of forming the surface coating film. Thus, there may arise a case where a problem occurs in view of the decorativeness. The cracking is a major problem in the applications to automotive glass, etc., in which a high transparency is required. In order to inhibit the cracking by suppressing the polymerization shrinkage, a method is available in which a mixture of tetraalkoxy silane and trialkoxy silane is used so as to decrease the number of functional groups which contribute to the polymerization. However, the thus generated films are not necessarily satisfactory in view of the performance, such as the hardness, and the like.

### SUMMARY OF THE INVENTION

It is therefore an object of the present invention to provide a surface coating film which is free from the cracking and which is good in terms of the wear resistance and superficial hardness. Moreover, it is another object of the present invention to provide a process for forming a surface coating film which is free from the cracking and which is good in terms of the wear resistance and superficial hardness.

In order to achieve the aforementioned objects, the inventors of the present invention studied the polymerization shrinkage wholeheartedly. As a result, they invented a surface coating film, which comprises: at least one member selected from the group consisting of silicon dioxide and silicon dioxide derivatives; and an additive including polyvinyl pyrrolidone (hereinafter abbreviated to “PVP”) being dispersed or solved therein. Moreover, they invented a process for forming a surface coating film, which comprises the steps of: applying a coating solution on a surface of a substrate, the coating solution including at least one silicon containing compound, being selected from the group consisting of alkoxy silane, siloxane and organosiloxane, and an additive including polyvinyl pyrrolidone; and heating the substrate.

Specifically, in accordance with the present invention, it is possible to improve the wear resistance and superficial hardness of the present surface coating film because PVP is dispersed or solved therein. Moreover, the toughness of the present surface coating film is enhanced as well so that the cracking does not occur when the present surface coating film is formed by the polymerization reaction of alkoxy silane, and the like.

As having described so far, the present surface coating film, in which silicon dioxide or a silicon dioxide derivative is a major component and in which the additive including PVP is dispersed or solved, is free from the cracking and is good in terms of the wear resistance and superficial hardness. Moreover, in accordance with the present process for forming a surface coating film, it is possible to form a surface coating film which is free from the cracking and is good in terms of the wear resistance and superficial hardness.

### BRIEF DESCRIPTION OF THE DRAWING

A more complete appreciation of the present invention and many of its advantages will be readily obtained as the same becomes better understood by reference to the following detailed description when considered in connection with the accompanying drawing and detailed specification, all of which forms a part of the disclosure:

FIG. 1 illustrates a schematic cross sectional view of an example of a surface coating film according to the present invention.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

A surface coating film according to the present invention is formed on a surface of a substrate, being one of resinous products. Depending on applications, the material quality, the shape, and so on, of the substrate are determined. For example, in an application in which a transparency is required, it is possible to name polycarbonate (PC), polyester, polyether sulfonate, thermoplastic resins and thermosetting resins. The polyester can be polyethylene terephthalate, polyethylene naphthalate, etc. The thermoplastic resin can be polyamide, polyallylate, non-crystalline polyolefine, polyphenylene sulfide, modified polyvinyl alcohol, etc. The thermosetting resin can be epoxy-based resins, acryl-based resins, silicone-based resins. The acryl-based resin can be polymethyl methacrylate, etc. In particular, PC is a preferable option not only in view of the transparency but also in view of the other favorable mechanical properties. Then, in a case where the substrate is applied to mechanical elements, such as gears, a resin being required therefor is selected taking mechanical properties, such as the strength, toughness, and the like, into consideration. Moreover, taking not only the superficial strength but also the rust resistance into consideration, it is possible to select aluminum (Al) as the substrate instead of the resins.

As for a position of a surface of a substrate on which the present surface coating film is formed, the present surface coating film can be formed at any position which requires performance, such as the hardness, and so on. For example, when the present surface coating film is applied to an automotive moon roof, etc., it is formed on the inner and outer surfaces entirely. When it is applied to a gear, it is formed on the tooth surfaces as well as the portions neighboring thereto. Before the present surface coating film is formed on a surface of a substrate, a superficial hardness can fall in a range of from “B” to “2B” approximately as per Japanese Industrial Standard (hereinafter abbreviated to as “JIS”) on the hardness of pencils. After the present surface coating film is formed on a surface of the substrate, a superficial hardness can fall in a range of from “2H” to “3H” approximately as per the JIS.

As for a thickness of the present surface coating film, an appropriate dimension is determined depending on the required performance. However, when the resulting present surface coating film is thickened to more than 20 μm approximately, the cracking is likely to occur. When it is thinned out, it is impossible to satisfy the wear-resistance and scratch-resistance requirements. For instance, when it is thinned out to less than 0.5 μm, even a superficial hardness is lowered as well. When a latter-described primer layer is excluded, the thickness of the present surface coating film can preferably be from about 0.5 to 20 μm, further preferably be from about 1 to about 10 μm.

In the present surface coating film, at least one of silicon Namely, the present surface coating film is a 3-dimension network-structured polymer which has Si—O bonds as repetition units and in which organic functional groups are bonded properly to silicon atoms. Note that so-called inorganic glass can constitute portions of the present surface coating film to which no organic functional group is bonded. The less organic functional groups are bonded to the present surface coating film, the more the present surface coating film is improved in terms of the hardness and wear resistance.

In the present surface coating film, PVP is dispersed or solved. Note that “being dispersed or solved” herein means that it does not matter how PVP exists in the present surface coating film. For example, PVP can exist as particles of PVP or isolated molecules in the present surface coating film.

In the present specification, “polyvinyl pyrrolidone (PVP)” is a concept which implies not only homopolymers of polyvinyl pyrrolidone but also copolymers of polyvinyl pyrrolidone and the other monomers. However, except for the case where a copolymer is needed especially, it is preferable to use a homopolymer in view of the availability, and the like.

It is believed that PVP can preferably have a small molecular weight because the less molecular weight PVP has the more PVP is improved in terms of the dispersibility in silicon dioxide and/or silicon dioxide derivatives. However, when PVP has an exceptionally small molecular weight, it has leaked out of the resulting surface coating film. Therefore, PVP can preferably such a weight average molecular weight of from about 40,000 to about 360,000. Note that it is preferable in general to use all of commercially available homopolymers of PVP whose grade “K” is 15, 30, 60, 90, and so on. In particular, it is further preferable to use a homopolymer of PVP whose grade “K”, is 30 or 90. The grades “K”=15, 30, 90, and so on, herein mean that homopolymers of PVP which have a weight average molecular weight of 10,000, 40,000, 360,000, and so, respectively.

In the present surface coating film, PVP can preferably be added in such an amount of from about 1% to 20% by weight, further preferably from about 2.5% to about 10% by weight. When PVP is added in this range, not only it is possible to produce advantages (i.e., sufficient improvements in terms of the wear resistance and superficial hardness) by the addition of PVP, but also it is possible to avoid a problem in that the inherent hardness of the present surface coating film is lowered by the addition of PVP. Unless otherwise specified, the term, “% by weight,” implies “% by mass” in the SI system.

Moreover, the present surface coating film can be provided with a primer layer on one of its opposite sides, which faces a substrate, in order to enhance the adherence to the substrate or to upgrade the affinity thereto. For example, when a substrate is formed of PC, it is possible to use resins, which exhibit a high affinity to both of the substrate and silicone dioxide and/or silicon dioxide derivatives, in order to make a primer layer. For instance, a primer layer can be films which are formed independently of one member, being selected from the group consisting of methacrylic acid-based resins and polyvinyl-based resins, or films in which two or more members, being selected therefrom, are mixed. These resins example, it is possible to name polymers, which are made from monomers, such as methylmethacrylate (MMA) having a polymerizable unsaturated group, by carrying out radical polymerization in an organic solvent, or polymers, emulsions, and the like, which are prepared by carrying out emulsion polymerization.

In this instance, it is possible to use monomers, which have a ploymerizable methylmethacrylate group, in order to form the aforementioned methacrylic acid-based resins. Specifically, it is possible to name the following: CH₂═CHCOOCH₃, CH₂═C(CH₃)COOCH₃, CH₂═CHCOOCH₂CH₂OH, CH₂═C(CH₃)COOCH₂CH₂OH, CH₂═CHCOOCH₂CH₂CH₃, CH₂═C(CH₃)COOCH₂CH₂CH₃, CH₂═CHCONHCH₃, CH₂═C(CH₃)CONHCH₃, CH₂═CHCON(CH₃)₂, CH₂═C(CH₃)CON(CH₃)₂, CH₂═CHCONHCH₂OH, CH₂═C(CH₃)CONHCH₂OH,

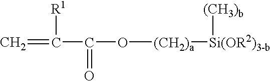

wherein R¹ specifies a hydrogen atom or a methyl group, R² specifies a monovalvent hydrocarbon group whose number of carbon atoms is from 1 to 6 (e.g., an alkyl group, an alkenyl group, a phenyl group, etc.), “a” is an integer of from 1 to 3 and “b” is 0 or 1,

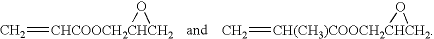

However, in the present surface coating film, the monomer for forming the methacrylic acid-based resins is not limited to these monomers. In addition, as far as the objects of the present invention are not impaired, it is possible to use monomers or polymers, which have an unsaturated group being capable of copolymerizing with the aforementioned monomers, in order to prepare the resins for forming the primer layer by copolymerization.

Moreover, as for vinyl-based monomers for forming the polyvinyl-based resins, it is possible to name monomers containing an alkoxy siliyl group, monomers which are expressed by the following chemical formula:

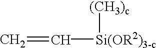

wherein R² specifies a monovalvent hydrocarbon group whose number of carbon atoms is from 1 to 6 (e.g., an alkyl group, an alkenyl group, a phenyl group, etc.) and “c” is 0 or 1.

As for the aforementioned monomers containing an alkoxy siliyl group, it is possible to name vinyl trimethoxy silane, vinyl triethoxy silane, vinyl methyl dimethoxy silane, vinyl methyl diethoxy silane, and the like. In addition to these silanes, it is possible to use the other vinyl-based monomers which do not contain any silicon atom.

As for a resinous component for forming the primer layer, it is possible to properly use acryl-based resins containing a trialkoxy siliyl group, acryl-based resins which are expressed especially by the chemical formula set forth below. Therefore, it is possible to appropriately use resinous components which are prepared by polymerizing or copolymerizing methacrylic acid-based monomers containing a trialkoxy siliyl group. Accordingly, not only the resulting resinous components can be cured by heating to form much denser films, but also they are advantageous for enhancing the adherence between the present surface coating film and the substrate.

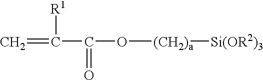

wherein R¹ specifies a hydrogen atom or a methyl group, R² specifies a monovalvent hydrocarbon group whose number of carbon atoms is from 1 to 6 (e.g., an alkyl group, an alkenyl group, a phenyl group, etc.) and “a” is an integer of from 1 to 3.

Specifically, as for the aforementioned methacrylic acid-based monomers containing a trialkoxy siliyl group, it is possible to name methacryloxy propyl trimethoxy silane, methacryloxy propyl triethoxy silane, acryloxy propyl trimethoxy silane, acryloxy propyl triethoxy silane, and so on.

The primer can preferably have a thickness of from 0.1 to 20 μm approximately. Note that, even when a resin, such as polyethylene terephthalate, acryl-based resins, etc., which exhibits a high affinity to silicon dioxide and/or silicon dioxide derivatives, is used for forming the substrate, it is preferable to dispose a primer layer because it is possible to prepare the present surface coating film of much higher performance.

The process according to the present invention for forming the present surface coating film comprises the steps of applying a coating solution on a surface of a substrate; and heating the substrate. The coating solution includes at least a silicon containing compound and an additive. The silicon containing compound is selected from the group consisting of alkoxy silane, siloxane and organosiloxane. The additive includes PVP.

Alkoxy silane is a compound which is prepared by substituting hydrogen atoms of monosilane with alkoxy groups in a quantity of from 1 to 4. The more the quantity of the hydrogen atoms substituted with alkoxy groups is, the more it is possible to upgrade the resulting present surface coating film in terms of the wear resistance and superficial hardness. As for the alkoxy group, it is possible to exemplify lower alkoxy groups, alkoxyl groups whose number of carbon atoms is from 1 to 6, and the like. The lower alkoxy group can be a methoxy group, an ethoxy group, a propoxy group, a butoxy group, and so on. The propoxy group can be a n-propoxy group and an iso-propoxy group. The butoxy group can be a n-butoxy group, an iso-butoxy group and a tert-butoxy group. Moreover, it is possible to further substitute the hydrogen atoms, which have not been substituted with the alkoxy groups, with lower alkyl groups, phenyl groups, hydroxyl groups, etc. Similarly to the substitution of hydrogen atoms with the alkoxy groups, the substitution of hydrogen atoms with hydroxyl groups contributes to the enhancement of the wear resistance and superficial hardness of the resulting present surface coating film. As for the alkoxy silane, tetraalkoxy silane is a preferable option. In particular, considering availability and handiness, it is possible to suitably use the following: dimethyl dimethoxy silane, methyl trimethoxy silane, tetramethoxy silane, dimethyl diethoxy silane, methyl triethoxy silane, tetraethoxy silane, γ-glycidoxy propyl trimethoxy silane, γ-glycidoxy propyl triethoxy silane, γ-glycidoxy propyl methyl dimethoxy silane, γ-glycidoxy propyl methyl diethoxy silane, and so on.

Organosiloxane is a compound in which lower alkyl groups, phenyl groups, alkoxy groups, hydroxyl groups, and the like, are bonded to silicon atoms of siloxane. Organosiloxane has an alkoxy group or a hydroxyl group in a quantity of one or more at least. Note that, in the organosiloxane, the number of the repetitions of “Si—O” unit is not limited in particular.

Note that the silicon containing compound involves a compound which has two or more hydroxyl groups with respect to one molecule. When the silicon containing compound includes a compound, which has hydroxyl groups in a quantity of less than two with respect one molecule, only, it is not possible to polymerize such a silicon containing compound to a high molecular weight. In the present surface coating film forming process, no cracks are caused by polymerization. Accordingly, it is possible to use a multi-functional silicon containing compound only as the silicon containing compound which is included in the coating solution. The multi-functional silicon containing compound herein means silicon containing compounds which have four or more functional groups. For example, the multi-functional silicon containing compound can be tetraalkoxy silane.

Since the hydroxyl group exhibits a low stability, it is preferable to synthesize hydroxyl groups by hydrolyzing alkoxy groups in view of the stability during storage, and the like, of the silicon containing compound. It is possible to hydrolyze part of or all of alkoxy groups by adding water to the coating solution before the coating solution is applied on a surface of the substrate or after the coating solution is applied thereon. It is possible to adjust the hydrolysis proportion of alkoxy groups by controlling the addition amount of water. As for the silicon containing compound, tetraalkoxy silane is a preferable option in view of the availability and handiness as well as the performance of the resulting present surface coating film. When the silicon containing compound is hydrolyzed, an acid catalyst, and so on, can be added, if necessary.

Since PVP is the same as the one which has been set forth above in the descriptions on the present surface coating film, it is not described again herein.

Moreover, it is possible to add colloidal silica to the coating solution. By adding colloidal silica thereto, the resulting present surface coating solution can exhibit an enlarged superficial hardness and an improved Tabor Abrader wear characteristic.

The coating solution can be prepared by solving the silicon containing compound, PVP, and the like, into a proper solvent. For instance, the proper solvent can be water, alcohol, and so on. Although a preferable solids content of the coating solution depends on the methods of applying the coating solution to the substrate, it can preferably be from about 5% to about 40% by weight. The methods of applying the coating solution will be described later.

The method of applying the coating solution on a surface of the substrate is not limited in particular. It is possible to carry out the application of the coating solution by ordinary methods, such as flow coating, spin coating, and the like.

Before applying the coating solution on a surface of the substrate, it is possible to dispose the above-described primer layer on a surface of the substrate. As for the method of disposing the primer layer, it is possible to exemplify the following process, and so on, which comprises the steps of: applying a primer solution, in which components for forming a primer layer is solved in a solvent, on a surface of the substrate; removing the solvent thereafter; and polymerizing the components.

In the heating step, the substrate is heated at a predetermined temperature for a predetermined time after the coating solution is applied on a surface of the substrate. The predetermined temperature and predetermined time can be adjusted in such ranges that the resin constituting the substrate can withstand. For instance, the temperature can preferably be from room temperature to about 150° C. Since the higher the temperature is the faster the reaction rate augments, it is possible to shorten the time required for reactions (i.e., the predetermined time).

### EXAMPLE NO. 1

A sheet was prepared which was made from PC and worked as the substrate. The PC sheet had a size of “A4” and a thickness of 0.5 mm, was produced by Mitsubishi Gas Kagaku Co., Ltd., and had a trade name, Eupilon Sheet “NF-2000.” A primer layer was formed on one of the opposite surfaces of the PC sheet by flow coating an acryl-based primer solution. The acryl-based primer solution was produced by Nihon Dacroshamlock Co., Ltd., had a trade name, “85B,” and included non-volatile components in an amount of from 10% to 15% by weight. After leaving the PC sheet at room temperature for 20 minutes, the PC sheet was placed in a constant-temperature chamber, which was held at 80° C., for 30 minutes to cure the acryl-based primer solution. The resulting primer layer had a thickness of from 2 to 5 μm.

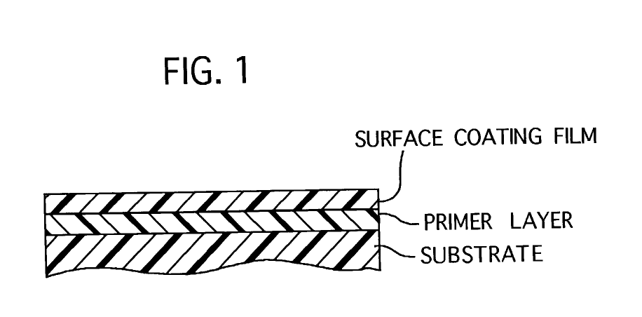

On the PC sheet with the primer layer formed, a coating solution was applied by flow coating. The coating solution was prepared by solving PVP into a silicon containing compound solution in an amount of 10% by weight with respect to the contents of solid components in the silicon containing compound solution. The silicon containing compound solution was produced by Nihon Dacroshamlock Co., Ltd., had a trade name, Sol Guard “RF0821,” and included non-volatile components in an amount of from 18% to 20% by weight. The PVP worked as the additive, was produced by Kanto Kagaku Co., Ltd., and had a trade name, “PVP K=30.” The applying step was thus carried out. After leaving the PC sheet at room temperature for 20 minutes, the PC sheet was placed in a constant-temperature chamber, which was held at 120° C., for 60 minutes to cure the coating solution. Thus, the heating step was carried out. The thus formed surface coating film had a thickness of from 5 to 10 μm. The measurement of the thickness was carried out with a spectrophotometer. FIG. 1 illustrates a schematic cross sectional view of the resulting surface coating film.

### EXAMPLE NOS. 2-11 AND COMPARATIVE EXAMPLE NOS. 1-3

Except that the coating solutions were used which were prepared by varying the addition amount of “PVP K=30” from that of Example No. 1 as set forth in Table 1, test samples were produced in the same manner as Example No. 1. The resulting test samples were regarded as Example Nos. 2 through 6, respectively. Except that, instead of “PVP K=30,” “PVP K=90” was solved into the silicon containing compound solution in the addition amounts as set forth in Table 1, test samples were produced in the same manner as Example No. 1. The resulting test samples were regarded as Example Nos. 7 through 11, respectively. Except that “PVP K=30” was not used or was changed to “PEG,” test samples were produced in the same manner as Example No. 1. The resulting test samples were regarded as Comparative Example Nos. 1 through 3, respectively. Note that, in Table 1, the addition amounts are expressed in percentages by weight with respect to the content of the non-volatile components in the alkoxy silane solution (i.e., the silicon containing compound solution). Further, the thickness of the primer layer was 5 μm in all of the test samples. Furthermore, in Table 1, “PEG” designates polyethylene glycol.

### EXAMPLE NOS. 12-14 AND COMPARATIVE EXAMPLE NO. 4

A primer layer was formed on one of the opposite surfaces of the respective PC sheets in the same manner as Example No. 1. The resulting primer layers had a thickness of 5 μm, respectively.

Except that another silicon containing compound solution was used instead of the silicon containing compound solution used in Example No. 1, and that the addition amount of “PVP K=30” was varied to 0% by weight in Comparative Example No. 4, 2.50% by weight in Example No. 12, 5% by weight in Example No. 13 and 10% by weight in Example No. 14, respectively, to prepare the coating solutions, test samples were produced in the same manner as Example No. 1. Note that the another silicon compound containing solution was produced by Shin-etsu Kagaku Kogyo Co., Ltd., had a trade name, “KP85AN,” and included non-volatile components in an amount of 20% by weight.

### EXAMPLE NOS. 15-17 AND COMPARATIVE EXAMPLE NO. 5

A primer layer was formed on one of the opposite surfaces of the respective PC sheets in the same manner as Example No. 1. The resulting primer layers had a thickness was 5 μm, respectively.

Except that still another silicon containing compound solution was used instead of the silicon containing compound solution used in Example No. 1, and that the addition amount of “PVP K=30” was varied to 0% by weight in Comparative Example No. 5, 2.50% by weight in Example No. 15, 5% by weight in Example No. 16 and 10% by weight in Example No. 17, respectively, to prepare the coating solutions, test samples were produced in the same manner as Example No. 1. Note that the still another silicon containing compound solution was produced by Nihon ARC Co., Ltd., had a trade name, “C-210,” and included non-volatile components in an amount of 20% by weight.

### EXAMPLE NOS. 18-20 AND COMPARATIVE EXAMPLE NO. 6

Except that another primer solution was used instead of the acryl-based primer solution used in Example No. 1, and that the another primer solution was cured at 120° C. in a constant-temperature chamber for 30 minutes, the PC sheets with the primer layer formed thereon were prepared in the same manner as Example No. 1. Note that the another primer solution was produced by Shin-etsu Kagaku Kogyo Co., Ltd., had a trade name, “PC-7A,” and included non-volatile components in an amount of 9% by weight. Moreover, the resulting primer layers had a thickness of 5 μm, respectively.

Thereafter, except that the addition amount of “PVP K=30” was varied to 0% by weight in Comparative Example No. 6, 2.50% by weight in Example No. 18, 5% by weight in Example No. 19 and 10% by weight in Example No. 20, respectively, to prepare the coating solutions, test samples were produced in the same manner as Example No. 1.

### EXAMPLE NOS. 21-23 AND COMPARATIVE EXAMPLE NO. 7

Except that still another primer solution was used instead of the acryl-based primer solution used in Example No. 1, and that the still another primer solution was cured at 115° C. in a constant-temperature chamber for 30 minutes, the PC sheets with the primer layer formed thereon were prepared in the same manner as Example No. 1. Note that the still another primer solution was produced by Nihon ARC Co., Ltd., had a trade name, “P-6552,” and included non-volatile components in an amount of 18% by weight. Moreover, the resulting primer layers had a thickness of 5 μm, respectively.

Thereafter, except that the addition amount of “PVP K=30” was varied to 0% by weight in Comparative Example No. 7, 2.50% by weight in Example No. 21, 5% by weight in Example No. 22 and 10% by weight in Example No. 23, respectively, to prepare the coating solutions, test samples were produced in the same manner as Example No. 1.

### Testing and Evaluation

The respective test samples were examined visually for the occurrence of cracks. The test samples, in which no crack had occurred, were subjected to a Tabor Abrader wear test (as per JIS R3212). In the Tabor Abrader wear test, two “CS-10F” wear rings were combined with a 500-gram weight, respectively, and were rotated on the test samples. When the wear rings were rotated by 500 revolutions, the respective test samples were measured for their haze values (i.e., the haziness) with a haze meter. Note that the haze values were measured at 4 positions in the cycle track of the wear rings and their average values were calculated. In Tables 1 and 2, the wear resistance (i.e., the Tabor Abrader wear amount) is expressed by percentage (%). Specifically, the quotient multiplied by 100 (i.e., the difference between the post-wear-test haze value and the pre-wear-test haze value divided by the pre-wear-test haze value and multiplied by 100:

[{(Post-Wear-Test Haze Value)−(Pre-Wear-Test Haze Value)}/(Pre-Wear-Test Haze Value)]×100.

Table 1 summarizes the results on Example Nos. 1 through 11 and Comparative Example Nos. 1 through 3 altogether.

TABLE 1

| | | Addition Amount | Film Thickness | | Tabor Abrader |
|---|---|---|---|---|---|
| | Additive | (% by weight) | (μm) | Appearance | Wear Amount (ΔH, %) |
| Ex. No. 1 | PVP K = 30 | 10 | 5-10 | No Crack | 2.0 |
| Ex. No. 2 | PVP K = 30 | 2.5 | 9 | No Crack | 1.8 |
| Ex. No. 3 | PVP K = 30 | 5.0 | 10 | No Crack | 2.0 |
| Ex. No. 4 | PVP K = 30 | 7.5 | 10 | No Crack | 1.8 |
| Ex. No. 5 | PVP K = 30 | 10 | 11 | No Crack | 2.1 |
| Ex. No. 6 | PVP K = 30 | 15 | 13 | No Crack | 2.7 |
| Ex. No. 7 | PVP K = 90 | 2.5 | 12 | No Crack | 1.8 |
| Ex. No. 8 | PVP K = 90 | 5.0 | 12 | No Crack | 2.3 |
| Ex. No. 9 | PVP K = 90 | 7.5 | 15 | No Crack | 1.9 |
| Ex. No. 10 | PVP K = 90 | 10 | 17 | No Crack | 2.1 |
| Ex. No. 11 | PVP K = 90 | 15 | 20 | No Crack | 2.8 |
| Comp. Ex. No. 1 | None | Not Applicable | 9 | Cracked | Not Measured |
| Comp. Ex. No. 2 | PEG | 5-15 | 9-11 | Cracked | Not Measured |
| | W. Ave. | | | | |
| | M. W.: 600 | | | | |
| Comp. Ex. No. 3 | PEG | 5-15 | 9-12 | Cracked | Not Measured |
| | W. Ave. | | | | |
| | M. W.: 6,000 | | | | |

It is apparent from Table 1 that no crack occurred in the test samples of Example No. 1 through 11 in which PVP was used as the additive. On the other hand, in all of the test samples of Comparative Example Nos. 1 through 3, cracks occurred. Accordingly, it was impossible to use them in applications which required the transparency.

Then, in view of the Tabor Abrader wear amount values, it was possible to fully improve the wear resistance by such a small PVP addition amount of 2.5% by weight regardless of the difference between the weight average molecular weights. Moreover, since the results of the Tabor Abrader wear test on Example Nos. 1 through 5 and Example Nos. 7 through 10 were superior to those of Example Nos. 6 and 11, it was found out that the advantages of the PVP addition could be effected when PVP was added in an amount of less than 15% by weight, preferably 10% by weight or less. In addition, note that the PVP addition amounts in Example NOS. 1 through 6 corresponded to those in Example Nos. 7 through 11. Since the results exhibited by Example Nos. 2 through 6 were favorable over those exhibited by Example Nos. 7 through 11, it was showed that, regarding the weight average molecular weight of PVP, “PVP K=30 (weight average molecular weight: approx. 40,000)” was more preferable than “PVP K=90 (weight average molecular weight: approx. 360,000).”

TABLE 2

| | | Addition Amount | Film Thickness | | Tabor Abrader |
|---|---|---|---|---|---|
| | Additive | (% by weight) | (μm) | Appearance | Wear Amount (ΔH, %) |
| Ex. No. 12 | PVP K = 30 | 2.5 | 10 | No Crack | 5.0 |
| Ex. No. 13 | PVP K = 30 | 5.0 | 11 | No Crack | 4.3 |
| Ex. No. 14 | PVP K = 30 | 10 | 13 | No Crack | 5.2 |
| Ex. No. 15 | PVP K = 30 | 2.5 | 10 | No Crack | 3.0 |
| Ex. No. 16 | PVP K = 30 | 5.0 | 10 | No Crack | 3.2 |
| Ex. No. 17 | PVP K = 30 | 10 | 12 | No Crack | 3.5 |
| Ex. No. 18 | PVP K = 30 | 2.5 | 14 | No Crack | 2.3 |
| Ex. No. 19 | PVP K = 30 | 5.0 | 15 | No Crack | 2.1 |
| Ex. No. 20 | PVP K = 30 | 10 | 12 | No Crack | 2.1 |
| Ex. No. 21 | PVP K = 30 | 2.5 | 14 | No Crack | 2.1 |
| Ex. No. 22 | PVP K = 30 | 5.0 | 15 | No Crack | 2.2 |
| Ex. No. 23 | PVP K = 30 | 10 | 12 | No Crack | 2.6 |
| Comp. Ex. No. 4 | None | Not Applicable | 9 | Cracked | Not Measured |
| Comp. Ex. No. 5 | None | Not Applicable | 9 | Cracked | Not Measured |
| Comp. Ex. No. 6 | None | Not Applicable | 11 | Cracked | Not Measured |
| Comp. Ex. No. 7 | None | Not Applicable | 11 | Cracked | Not Measured |

Table 2 summarizes the results of the evaluation on Example Nos. 12 through 23 and Comparative Example Nos. 4 through 7 altogether. From the results exhibited by Example Nos. 12 through 23, set forth in Table 2, no crack was appreciated in all of Example Nos. 12 through 23 in which PVP was added as the additive. Consequently, it was evident that the advantages resulting from the PVP addition are hardly affected by the types of the silicon containing compound as well as the types of the primer layer.

Having now fully described the present invention, it will be apparent to one of ordinary skill in the art that many changes and modifications can be made thereto without departing from the spirit or scope of the present invention as set forth herein including the appended claims.

What is claimed is:

1. A surface coating film coated on a substrate, comprising:
at least one member being selected from the group consisting of silicon dioxide and silicon dioxide derivatives; and
an additive including polyvinyl pyrrolidone being dispersed or solved therein.

2. The surface coating film according to claim 1 further comprising a primer layer disposed on one of opposite sides of the surface coating film contacting with said substrate.

3. The surface coating film according to claim 2, wherein said primer layer has a thickness of from about 0.1 to about 20 μm.

4. The surface coating film according to claim 2, wherein said substrate is formed of polycarbonate; and said primer layer is formed of at least one member being selected from the group consisting of methacrylic acid-based resins and polyvinyl-based resins.

5. The surface coating film according to claim 4, wherein said primer layer is formed of a methacrylic acid-based resin being made from methylmethacrylate having a polymerizable unsaturated group by polymerization.

6. The surface coating film according to claim 1 having a thickness of from about 0.5 to about 20 μm.

7. The surface coating film according to claim 1, wherein said polyvinyl pyrrolidone has a molecular weight of from about 40,000 to about 360,000.

8. The surface coating film according to claim 7, wherein said polyvinyl pyrrolidone has a K-value of 30.

9. The surface coating film according to claim 1, wherein said polyvinyl pyrrolidone is included in an amount of from about 1% to about 20% by weight.

10. The surface coating film according to claim 9, wherein said polyvinyl pyrrolidone is included in an amount of from about not less than 1% to about less than 15% by weight.

11. The surface coating film according to claim 9, wherein said polyvinyl pyrrolidone is included in an amount of from about not less than 1% to about less than 10% by weight.

12. A process for forming a surface coating film, comprising the steps of:
applying a coating solution on a surface of a substrate, the coating solution including at least one silicon containing compound, being selected from the group consisting of alkoxy silane, siloxane and organosiloxane, and an additive including polyvinyl pyrrolidone; and heating the substrate.

13. The process according to claim 12, wherein a primer layer is formed on a surface of said substrate in advance.

14. The process according to claim 12, further comprising the step of:
applying to the substrate surface a primer layer prior to the application of the coating solution, whereby the coating solution is applied over the primer layer.

15. The process according to claim 12, wherein said silicon containing compound is a multi-functional silicon containing compound having four or more functional groups.

16. The process according to claim 12, wherein said coating solution has a solids content of from about 5% to about 40% by weight.

17. The process according to claim 12, wherein the substrate is heated at a temperature of from room temperature to about 150° C.
